(19) United States
(12) Patent Application Publication
(10) Pub. No.: US 2026/0347191 A1
(43) Pub. Date: Nov. 5, 2026

(54) COMPOSITES INCLUDING UNIMPREGNATED CELLULAR CARBON NONOSTRUCTURES

(71) Applicant: Dickinson Corporation, Novato, CA (US)

(72) Inventors: Matthew Bishop, Novato, CA (US); Abhay V. Thomas, Novato, CA (US); David Andrew Brill, Novato, CA (US)

(21) Appl. No.: 19/447,925

(22) Filed: Jan. 13, 2026

Related U.S. Application Data
(63) Continuation of application No. 16/493,473, filed on Mar. 15, 2018, now Pat. No. 12,545,586.
(60) Provisional application No. 62/471,711, filed on Mar. 15, 2017.

(51) Int. Cl. C01B 32/18; C08K 3/04; C09D 7/63; C09D 7/65

(52) U.S. Cl. CPC C01B 32/18; C08K 3/046; C09D 7/63; C09D 7/65; C01P 2004/03; C01P 2004/54; C01P 2006/40

(57) ABSTRACT

A composite, comprising a binder, the binder comprising one or more of polymeric, metallic, or ceramic, or pyrolytic carbon binder and a nanostructured carbon having a cellular structure. The cellular structure comprises one or more cell walls having a structure formed by a template and one or more cavities. Each cavity is substantially enclosed by the one or more cell walls and substantially unimpregnated by a liquid or solid.

### CROSS-REFERENCE TO RELATED ARM ICA-PIONS

This application is a continuation of U.S. patent application Ser. No. 16/493,473, filed Sep. 12, 2019, which is hereby incorporated by reference in its entirety for all purposes. U.S. patent application Ser. No. 16/493,473 is a national stage (371) of International Application No. PCT/US2018/022600, filed Mar. 15, 2018, and also claims the benefit of U.S. Provisional Patent Application No. 62/471,711, filed Mar. 15, 2017, each of which is incorporated by reference in its entirety for all purposes.

### BACKGROUND

Nanocomposites, placing nanostructured carbons into larger, heterogeneous structures, have been proposed. In particular, different kinds of sp²-hybridized carbon nanoparticles have been studied extensively because of their potential to improve the structural or electronic properties of composites used in structural, battery, and display technologies. “Zero-dimensional” carbon nanostructures, including Buckminster fullerenes and carbon quantum dots, have been the subject of intense academic activity for decades. So-called “one-dimensional” carbon nanostructures, including carbon nanotubes and nanofibers, have more recently been studied, as have “two-dimensional” carbon nanostructures such as graphene nanoplatelets. The studies of these low-dimensional (i.e. OD, 1D, or 2D) carbons reveal their extraordinary strength to weight ratios and electronic properties, suggesting that placing them in other materials would create composites with desirable properties. However, particles with low-dimensional geometries often present challenges compared to particles with three-dimensional geometries. For instance, particles with low-dimensional geometries tend to agglomerate or entangle and can be difficult to disperse evenly throughout a matrix.

Carbons with porous structures, on the other hand, have the potential to incorporate the advantageous attributes of low-dimensional particles without the challenges associated with low-dimensional particle geometries. Predictive modeling of 3D objects constructed from 2D grapheme, in particular, show outstanding compressive strength-to-weight ratios. One hypothetical example is the hollow 3D sphere formed by 2D graphene as the spherical surface. Real-world examples include self-assembled graphene aerogels. However, 3D graphene assemblies are difficult to synthesize, and may not have controllable pore morphology. Such assemblies may also be especially well-suited to electrochemical applications due to their porosity and electrical conductivity.

### SUMMARY

Described herein is a novel class of composite materials incorporating unimpregnated cellular carbons with templated cavity morphology. Some embodiments include a composite, comprising a binder comprising one or more of polymeric, metallic, or ceramic, or pyrolytic carbon binder and a nanostructured carbon. The nanostructured carbon may comprise one or more cell walls having a structure formed by a template and one or more cavities. Each cavity may be substantially enclosed by the one or more cell walls and substantially unimpregnated by a liquid or solid. A majority of the one or more walls may have a thickness of 100 nm or smaller. A majority of the cavities may have a diameter of 10 nm or larger and an aspect ratio of substantially less than 10:1. A majority of the cellular structures may have a diameter of 1 mm or smaller. The composite may be formed via template-directed chemical vapor deposition.

in some embodiments, the polymeric binder may be a thermoplastic. The thermoplastic may comprise at least one of the following: poly(methyl methacrylate), acrylonitrile butadiene styrene, polyamide, polylactic acid, polybenziinidazole, polycarbonate, polyether sulfone, polyoxymethylene, polyether ether ketone, polyetherimide, polyethylene, polyphenylene oxide, poiphenylene sulfide, polypropylene, polystyrene, polyvinyl chloride, polytetrafluoroethylene, or copolymers thereof. The polymeric binder may include a thermosetting polymer. The thermosetting polymer may comprise at least one of the following: polyester, polyurethane, polyurea, phenol-formaldehyde, urea-formaldehyde, epoxy, benzoxazine, polyimide, bismaleimide, polycyanurate, polysiloxane, vinyl ester, or blends thereof.

In some embodiments, the nanostructured carbon may comprise 1%, 10%, 50% or less of the composite by weight. The nanostructured carbon may be non-covalently bonded to the binder. The nanostructured carbon may be electrically conductive.

In some embodiments, the composite may be a powder. The composite may have a density that is substantially less than a density of the binder. The composite may have a density of 0.80 g/cm³ or less. The composite may have a density of 0.50 g/cm³ or less.

In some embodiments, the composite may have a compressive strength at 10% strain that is more than 140% greater than a compressive strength at 10% strain of the binder. The composite may have a compressive strength at 10% strain that is more than 600 0¹0 greater than a compressive strength at 10% strain of the binder. The composite may have an ultimate tensile strength that is more than 140% greater than an ultimate tensile strength of the binder. The composite may have a compressive modulus that is more than 640% greater than a compressive modulus of the binder. The composite may have a specific strength at 10% strain that is more than 400% greater than a specific strength at 10% strain of the binder. The composite may have a specific strength at 10% strain that is more than 790% greater than a specific strength at 10% strain of the binder. The composite may have a specific ultimate compressive strength that is more than 400% greater than a specific ultimate compressive strength of the binder. The composite may have a specific ultimate compressive strength that is more than 790% greater than a specific ultimate compressive strength of the binder. The composite may have a specific modulus that is more than 470% greater than a specific modulus of the binder. The composite may have a specific modulus that is more than 810% greater than a specific modulus of the binder.

Some embodiments include a film or coating, comprising a binder comprising one or more of polymeric, metallic, or ceramic, or pyrolytic carbon binder and a nanostructured carbon. The nanostructured carbon may comprise one or more walls having a structure formed by a template and one or more cavities. Each cavity may be substantially enclosed by the one or more walls and substantially unimpregnated by a liquid or solid. A majority of the one or more cell walls may have a thickness of 100 nm or smaller. A majority of the cavities may have a diameter of 10 nm or larger and an aspect ratio of substantially less than 10:1. A majority of the cellular structures may have a diameter of 1 mm or smaller.

Still more embodiments include a molded casting, comprising a binder comprising one or more of polymeric, metallic, or ceramic, or pyrolytic carbon binder and a nanostructured carbon having a structure. The nanostructured carbon may comprise one or more walls having a structure formed by a template and one or more cavities. Each cavity may be substantially enclosed by the one or more walls and substantially unimpregnated by a liquid or solid. A majority of the one or more cell walls may have a thickness of 100 nm or smaller. A majority of the cavities may have a diameter of 10 nm or larger and an aspect ratio of substantially less than 10:1. A. majority of the cellular structures may have a diameter of 1 mm or smaller.

Related PCT/US18/145 describes a 3D nanocomposite network with both 2D and 3D features in which templated carbon morphologies are utilized to impose controllable spacing between 2D carbon features. These features include cells and cavities in the carbon material that are formed via template-directed synthesis. Herein “cell” will be used to refer to a templated carbon structure containing an internal cavity. Cells may be present in either the carbon powder (e.g., S1-S3) or as embedded structures in composite (e.g., Cl and C2) materials. Cells generally inherit morphological properties from the template used to form them. Nanocomposites incorporated them, therefore, are referred to herein as “cellular carbon” nanocomposites. The cells impart a 3D structure with controllable spacing. In PCT/US18/145, the cells are “impregnated,” or filled, by a liquid or solid material that alters the properties of the composite. Impregnation of the cells with solid or liquid material may be deliberate. It also may also occur inadvertently. For example, cells may become impregnated due to infiltration of a liquid through pores or breaches in the cell wall.

“Unimpregnated” cellular composites, or composites with cells filled with gas or voids instead of solid or liquid material, have the potential to offer even more advantageous strength to weight ratios. Specifically, unimpregnated cellular composites may offer the structural rigidity of the cellular carbon framework while their gas- or void-filled cell structure simultaneously reduces its weight and density.

The composite materials described herein may possess a range of carbon weight fractions (e.g., from less than 1% to greater than 50%). The cells may be dispersed throughout the matrix. Alternatively, they may be packed densely throughout the matrix. The composites may take the form of powders, granulated powders, pellets, or liquid dispersions. The composites may be molded, coated, or printed.

One aspect is to provide a new class of composite materials with enhanced physical, mechanical, electrical, and thermal properties, and that may be fabricated into components using a number of manufacturing methods.

In addition to lowering density, unimpregnated cellular carbons may provide advantages over impregnated cellular carbons for nanocomposite applications, in particular. For example, unimpregnated cellular carbons may have more freedom to flex and to absorb kinetic energy than nanocomposites comprised of impregnated cell architectures. Unimpregnated carbons may also exhibit a lower electron scatter profile and lower electrical resistance, providing advantages for electrical nanocomposite applications. High-porosity unimpregnated cellular carbons may also be engineered to reduce the thermal conductivity in applications where thermal insulation is desirable. Additional advantages and applications will be readily apparent to those skilled in the art from the following detailed description.

### BRIEF DESCRIPTION OF THE FIGURES

The accompanying drawings, which are incorporated herein and constitute part of this specification, illustrate examples, and together with the general description given above and the detailed description given below, serve to explain the features of the disclosed systems and methods.

FIG. 1A is a Scanning Electron Microscopy (SEM) micrograph of a nesquehonite template precursor.

FIG. 1B is an SEM micrograph of an MgO template derived from calcining a nesquehonite powder.

FIG. 1C is an SEM micrograph of a cellular carbon structure grown on a nesquehonite-derived MgO template.

FIG. 2A is an SEM micrograph showing the cellular carbon particles of S1 carbon powder.

FIG. 2B is a magnification of an S1 particle 100 shown in FIG. 1D to allow calculation of that particle's aspect ratio.

FIG. 2C is an SEM micrograph showing the cellular carbon particles of S1 carbon powder at higher magnification.

FIG. 2D is a higher magnification of a portion of FIG. 2B showing cell walls 120a.

FIG. 3A is an SEM micrograph of the cellular carbon particles of S2 carbon powder.

FIG. 3B is a higher magnification of a portion of FIG. 3A showing unextracted MgO template materials trapped within a minor phase of cellular carbon particles. These impregnated cells appear less transparent.

FIG. 4 is an SEM micrograph of an individual carbon cell in which transverse pores through the cell walls have been covered by nearly-transparent carbon sheets.

FIG. 5 is an SEM micrograph of the cellular carbon particles of S3 carbon powder.

FIG. 6 is an SEM micrograph of C1 composite powder prior to densification.

FIG. 7 is an SEM micrograph of a cryo-ion beam milled cross-section of a compression-molded C1 sample specimen. Large, irregular micron-scale pores are distributed throughout the composite.

FIG. 8 is an SEM micrograph of the cryo-ion beam milled cross-section of the compression-molded C1 sample specimen. Intracellular or endohedral porosity corresponding to the S1 cell cavities can be observed, as well as larger intercellular voids.

FIG. 9A is an SEM micrograph of the cryo-ion beam milled cross-section of the compression-molded C1 sample specimen. A cluster of quasi-networked cells can be observed.

FIG. 9B is a magnified image of one of the cells in FIG. 9A.

FIG. 10 is an SEM micrograph of a cryo-ion beam milled cross-section of a compression-molded composite comprised of 10% cellular carbon and 90% CPO by weight. This image demonstrates the contrasting visual appearance of impregnated cells and unimpregnated cells.

FIG. 11 is an SEM micrograph of cellular carbons after being subjected to 250,000 psi of uniaxial compression. Linear buckling patterns are evident.

FIG. 12 is an SEM micrograph of collapsed spheroidal cellular carbons with crystalline lattices.

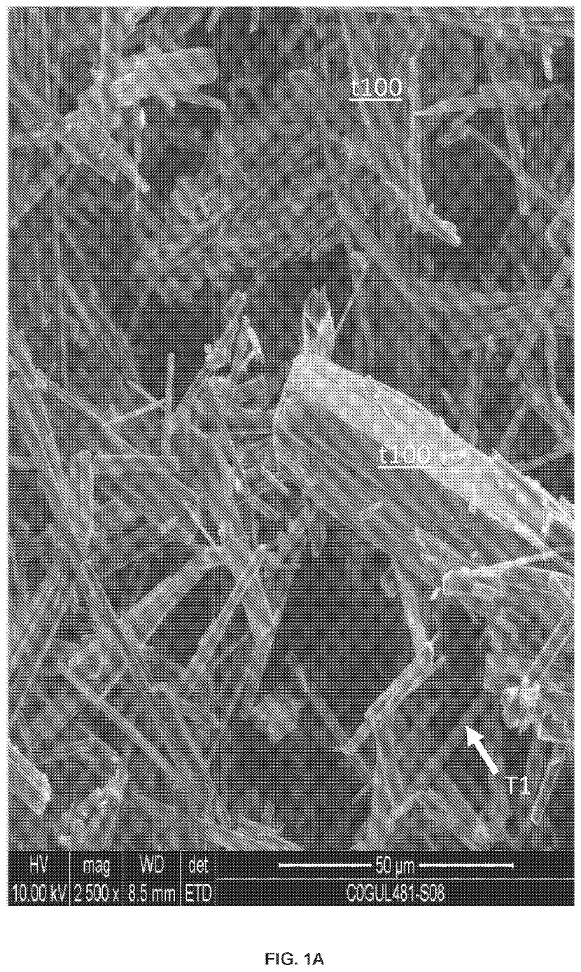

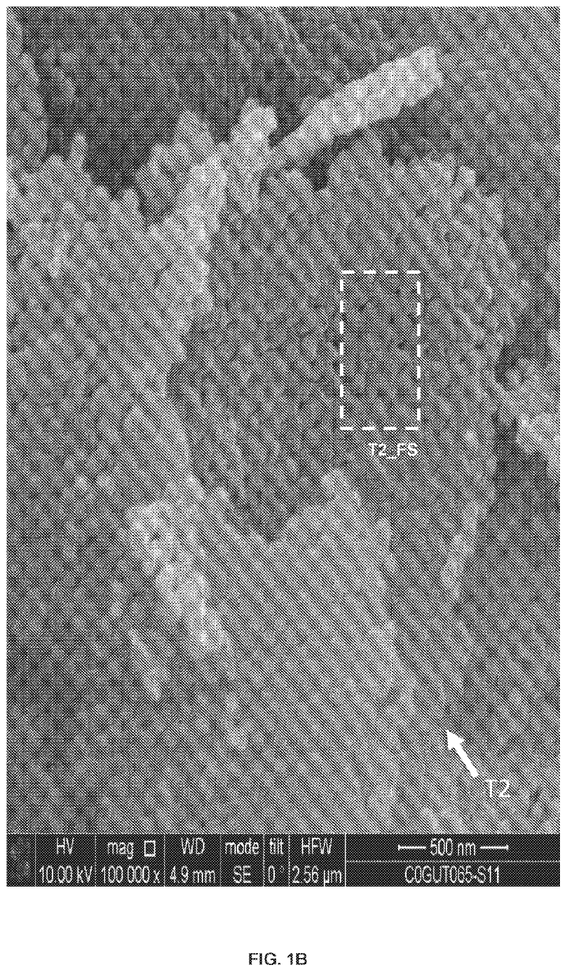

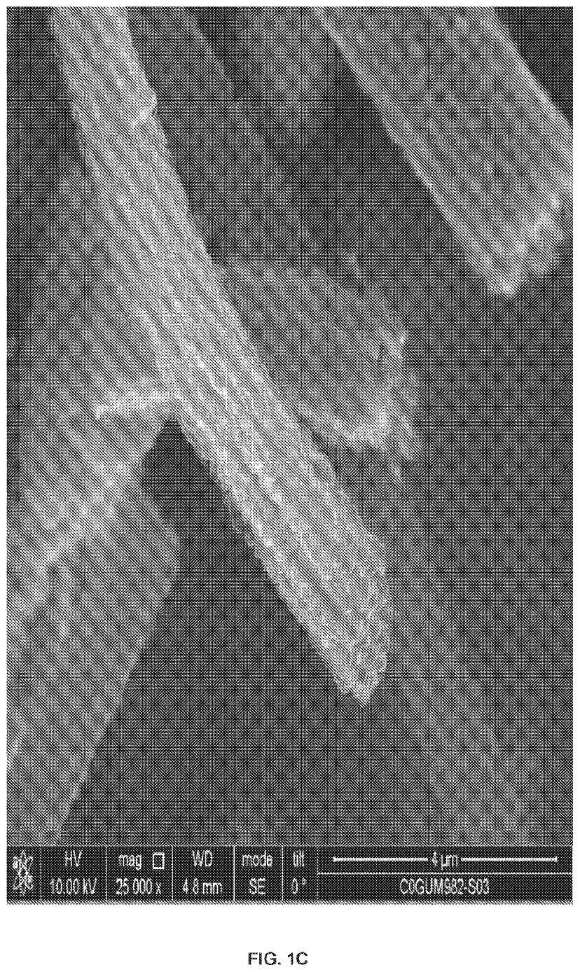

FIG. 1.3 is an SEM micrograph of a composite coating comprised of spheroidal cells coated with CPO.

FIG. 14 is an SEM micrograph of a composite particle scraped from the dried C3 coating.

### DETAILED DESCRIPTION

The examples and descriptions herein are to be regarded as illustrative in nature and not restrictive. Although particular exemplary methods of preparing the cellular carbon powder precursor materials and composites are described herein, it is to be understood that the instant disclosure is not limited to such methods of preparation. It is to be understood that the cellular carbons may be prepared according to any method disclosed herein, as well as any of the methods described in PCT/US18/14549 and PCT/US17/17537, both of which are incorporated by reference.

The following disclosure describes embodiment composites and methods of manufacturing exemplary cellular carbon powders. Cellular carbon powders may be synthesized via template-directed chemical vapor deposition (“CVD”) in an MTI rotary tube furnace outfitted with having an outer diameter (“OD”) of 100 mm stainless steel flanges, gas feed inlets and a single gas outlet. All process gases may be sourced from Praxair, Inc.

Despite that CVD is presented herein as an exemplary growth method, it is to be understood that CVD is just one of many processes that can produce templated carbons in the manner described. Other exemplary methods that could be used include, for example, coating a template with an organic or polymeric precursor shell followed by pyrolyzing the precursor shell, or adhering oxidized graphitic nanoplatelets to solid- or liquid-state templates. In each case, the use of the template imparts a deterministic structure to the cellular carbon synthesized around it.

As mentioned above, CVD growth of the cellular carbon structures, as described herein, may be template-directed. Use of templates to form carbon powders of the various embodiments may create cellular carbons that differ in particle and cellular structure. Exemplary templates include MgO powder, as described in further detail below. However, it is to be understood that the instant disclosure is not limited to using such templates, nor to the other particular templates described herein. Other exemplary templates include, but are not limited to, oxides other than MgO (including mixed oxides such as silicates), carbonates, halides, sulfates, phosphates, polymers, droplets in emulsions, and bubbles. Some exemplary processes for growing cellular carbons, as well as additional template materials, have been described in greater detail in PCT/US17/17537.

Other differences in the morphology of the cellular carbons may result from varying certain process parameters, such as pre-CVD heating of templates. It is to be understood that variations of such parameters are within the scope of the instant disclosure, whether explicitly mentioned or not.

In a first embodiment, carbon powder sample may be synthesized using hydrated magnesium carbonate (MgCO₃) in the form of “nesquehonite” (N—MgCO₃) rods as a template precursor. The nesquehonite may be “calcined,” or heated to the point of decomposition, evolving CO₂ and H₂O and resulting in an MgO template, prior to the CVD procedure used to create a powder according to the first embodiment. A propylene/argon mixture may be employed as the CVD feed gas.

FIGS. 1A-1B show the template structures during the various stages of this embodiment. FIG. 1A shows the structure of the nesquehonite template precursor Ti. One can readily observe from FIG. 1A that nesquehonite particles t100 are rod-shaped and have a high “aspect ratio” (e.g., length to width) of substantially greater than 10:1. In some cases, the nesquehonite particle aspect ratio is greater than 50:1. FIG. 1B shows an MgO template T2 derived from calcining nesquehonite. In particular, FIG. 1B shows the fine structure T2 FS of the resultant MgO, which exhibits discretized features with the cubic MgO habit. Although not shown in FIG. 1B, the MgO template retains the rod-like, high-aspect ratio particle structure of the nesquehonite precursor shown in FIG. 1A. This fine structure and rod-like particle structure are imparted to the cellular carbon structure, as described in more detail below.

According to the first embodiment, the procedure to produce Si may be as follows. N—MgCO₃ may be prepared via room temperature air sparging of a magnesium bicarbonate (Mg(HTMgCO₃)₂) solution. The N—MgCO₃ may be filtered from the solution and evaporatively dried. The dried N—MgCO₃ may be subjected to ball milling followed by drying at 300 °C overnight before being used as the substrate for carbon production. 600 g of N—MgCO₃ may be loaded into a quartz tube (OD 100 mm) inside the furnace's heating zone. The tube may be rotated at a speed of 2.5 rpm during the ramp, growth and cool-down stages. The reactor may be ramped from room temperature to a temperature setting of 750 °C over 30 minutes and maintained at that temperature for 30 minutes under 500 sccm Ar flow in order to produce the MgO template. Next, a 165 sccm C₃H₆ flow may be initiated while holding Ar flow unchanged. This may be continued for 30 minutes. The C₃H₆ flow may then be discontinued and the reactor may be allowed to cool to room temperature under continued Ar flow.

During the temperature ramp and hold the MgCO₃ may be converted to an MgO template/substrate for carbon growth. Subsequent to carbon growth, the MgO template may be extracted by acid-etching with hydrochloric acid (HCl), resulting in a slurry of carbon in an aqueous magnesium. chloride (MgCl₂) brine. The carbon may then be filtered from the brine, rinsed with deionized water three times, and collected as an aqueous paste. A solvent exchange process may then be used to replace the water with acetone, which may result in an acetone/carbon paste. The paste may then be evaporatively dried to form a dry carbon powder (S1) according to the first embodiment.

The cells or cavities of the porous powder according to the first embodiment may be sealed with thin sheets of carbon via a secondary CVD process, wherein the cell wall is further grown via autocatalysis. More details regarding this procedure and the mechanisms involved are discussed in PCT/US17/17537. About 4.8 g of the dry carbon powder may be loaded into a quartz tube (e.g., a tube having an outer diameter (OD) of 60 mm) inside the furnace's heating zone. The quartz tube may then be rotated at a speed of 10 rpm during the temperature ramping described below, as well as the growth and cool-down stages. The CVD reactor may be ramped from room temperature to a temperature setting of 750 °C over 30 minutes. The rector temperature may then be maintained at 750 °C for 30 minutes under 500 sccm Ar flow. Next, a 85 sccm C₃H₆ flow may be initiated while holding Ar flow steady at 500 sccm. This may be continued for 2 minutes. The C₃H₆ flow may then be discontinued and the reactor may be allowed to cool to room temperature under continued Ar flow. “S I” herein will refer to the carbon powder obtained after this secondary CVD process, according to the first embodiment.

In a second embodiment, the template used to form the carbon powder during CVD may be MgO particles made from Elastomag 170 “EL-170” MgO sourced from Akrochem, Inc. A propylene/argon mixture may be employed as the feed gas during CVD.

The procedure to produce an exemplary powder (S2) according to the second embodiment may be as follows. The as-received EL-170 may be calcined at 900 °C for 15 hours before use. A 500 g sample of EL-170 may be loaded into the quartz tube inside the furnace's heating zone. The tube may be rotated at a speed of 10 rpm during the ramp, growth and cool-down stages. The reactor may be ramped from room temperature to a temperature setting of 750 °C over 30 minutes and maintained at 750 °C for 30 minutes under 500 sccm Ar flow. Next, a 1050 sccm C₃H₆ flow may be initiated while holding Ar flow unchanged. This may be continued for 30 minutes. The C₃H₍, flow may then be discontinued and the reactor may be allowed to cool to room temperature under continued Ar flow.

The MgO may then be extracted by acid-etching with HCl, resulting in a slurry of carbon in an aqueous MgCl₂ brine. The carbon may then be filtered from the brine, rinsed with deionized water three times, and collected as an aqueous paste. A solvent exchange process may then be used to replace the water with acetone, resulting in an acetone/carbon paste. The paste may then be evaporatively dried to form a dry carbon powder.

The cells or cavities of the porous S2 powder may be sealed with thin sheets of carbon via a secondary CVD process, wherein the cell wall is further grown via autocatalysis. This procedure and the mechanisms involved have been discussed in PCT/US17/17.537. For example, about 4.8 g of the dry carbon powder may be loaded into the quartz tube inside the furnace's heating zone. The tube may be rotated at a speed of 10 rpm during the ramp, growth and cool-down stages. The reactor may be ramped from room temperature to a temperature setting of 750 °C over 30 minutes and maintained at that temperature for 30 minutes under 500 sccm Ar flow. Next, an 85 sccm C₃H₆ flow may be initiated while holding Ar flow unchanged. This may be continued for 3 minutes. The C₃H₆ flow may then be discontinued and the reactor may be allowed to cool to room temperature under continued Ar flow. “S2” will refer herein to an exemplary carbon powder obtained after this secondary CVD process, according to the second embodiment.

In a third embodiment, the template used to form the carbon powder during CVD may be MgO particles made from EL-170, the same template feedstock used for the second embodiment. A propylene/argon mixture may be employed as the feed gas during CVD.

The procedure to produce a powder according to the third embodiment may be as follows. A 500 gram sample of E1-170 may be loaded into the quartz tube inside the furnace's heating zone. The reactor may be ramped from room temperature to a temperature setting of 1050 °C over 30 minutes and maintained at that temperature for 30 minutes under 500 sccm Ar flow. The reactor may then be cooled to 750 C in 30 minutes and allowed to equilibrate at 750 C for 30 minutes. At 750 °C, a 250 sccm C₃H₆ flow may be initiated while holding Ar flow unchanged. This may be continued for 60 minutes. The C₃1-I₆ flow may then be discontinued and the reactor may be allowed to cool to room temperature under continued Ar flow.

The MgO may then be extracted by acid-etching with HCl, resulting in a slurry of carbon in an aqueous MgCl₂ brine. The carbon may then be filtered from the brine, rinsed with deionized water three times, and collected as an aqueous paste. A solvent exchange process may then be used to replace the water with acetone, resulting in an acetone/carbon paste. The paste may then be evaporatively. An exemplary carbon powder obtained according to this third embodiment will be referred to herein as “S3.”

### Comparison of Si, S2, and S3 Powder Structures

SEM micrographic analysis was performed on powder prepared according to the first, second, and third embodiment procedures in order to understand their nanostructure and microstructure.

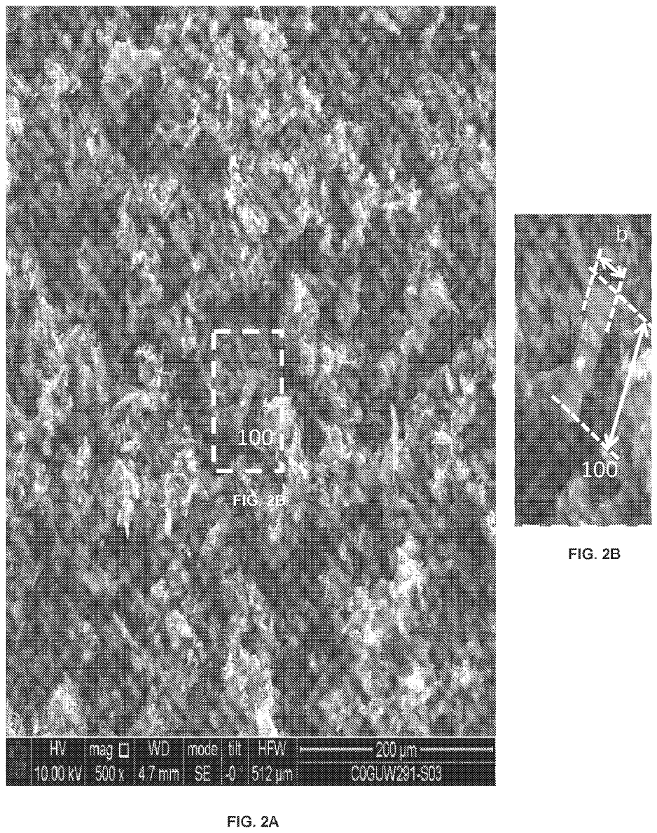

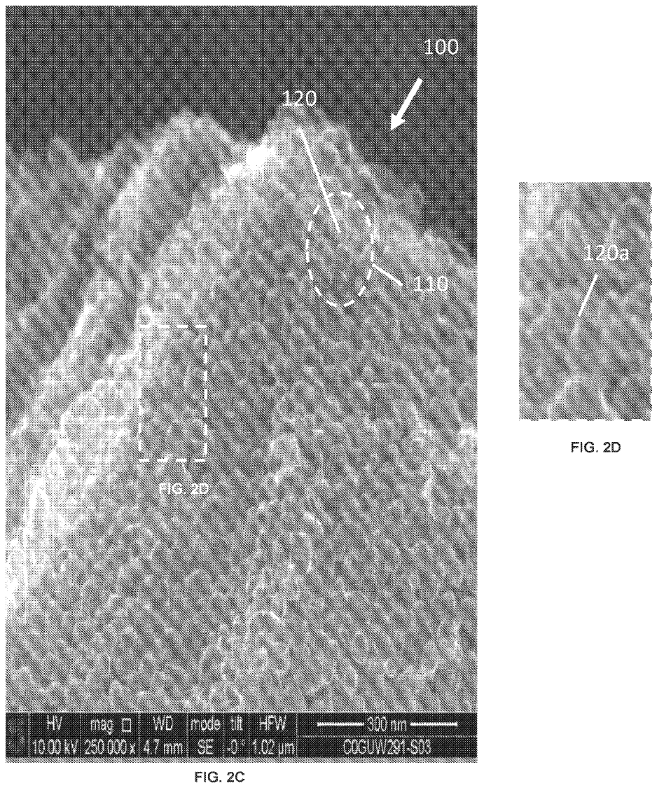

FIG. 2A shows a powder sample (Si) fabricated according to the first embodiment. In FIG. 2A several individual particles, such as particle 100, appear to have a rod-like structure similar to the individual particles of the Nesquehonite template particles t100 shown in FIG. 1 A. It appears, however, that the ball milling process used to generate Si results in truncation of the relatively high aspect ratio (i.e., greater than 10:1) of the nesquehonite template precursor particles. A quick glance at FIG. 2A reveals that the average particle in S1 has an aspect ratio that is less than 10:1.

FIG. 2B is a magnification of particle 100 in FIG. 2A. FIG. 2B shows that the aspect ratio (a/b) of exemplary’ particle 100 is close to 3:1, reflecting the inherited microstructure of the nesquehonite-derived MgO template. However, it may be observed in FIG. 2C and FIG. 2D that the aspect ratio of the cavities formed by the fine structure (T2_FS of the nesquehonite-derived MgO, as shown in FIG. 1B) is less than the 3:1 ratio of exemplary particle 100. As indicated in FIG. 2C, the particles comprise multicellular clusters of individual cells 120. The individual cells 120 are smaller than 100 nm in diameter. In SEM, cells 120 appear in the SEM image as partially transparent. If the cells 120 include a portion of template or liquid filler, they would appear opaque. Therefore, the transparent appearance in FIG. 2C of the cells 120 indicates both that the MgO template that formed the cells has been removed and that they are unimpregnated by other solid or liquid.

The gas filling the cells 120 is typically the ambient gas present when the template is extracted. However, it is to be understood that the gas may be any suitable gas. For example, it may be desirable to fill the cells 120 with an inert gas to delay chemical reactions. It may be desirable to fill the cells 120 with gas at ambient pressure. However, it is possible to till the cells 120 with gas at any suitable pressure. For example, it may be desirable to fill the cells 120 with gas at an elevated pressure with respect to the ambient pressure in the environment in which the carbon or composite including the cells 120 will be deployed. Doing so may impart a positive pressure on the inside walls of cells 120, potentially improving cell 120 rigidity and/or shape memory.

FIG. 2D is a magnification of the indicated portion of FIG. 2C showing cell walls 120a. As seen in FIG. 2D, cell walls 120a show up relatively clearly in SEM thanks to the high contrast image. FIGS. 2C/2D show that the cell walls 120a are only a few nanometers in thickness.

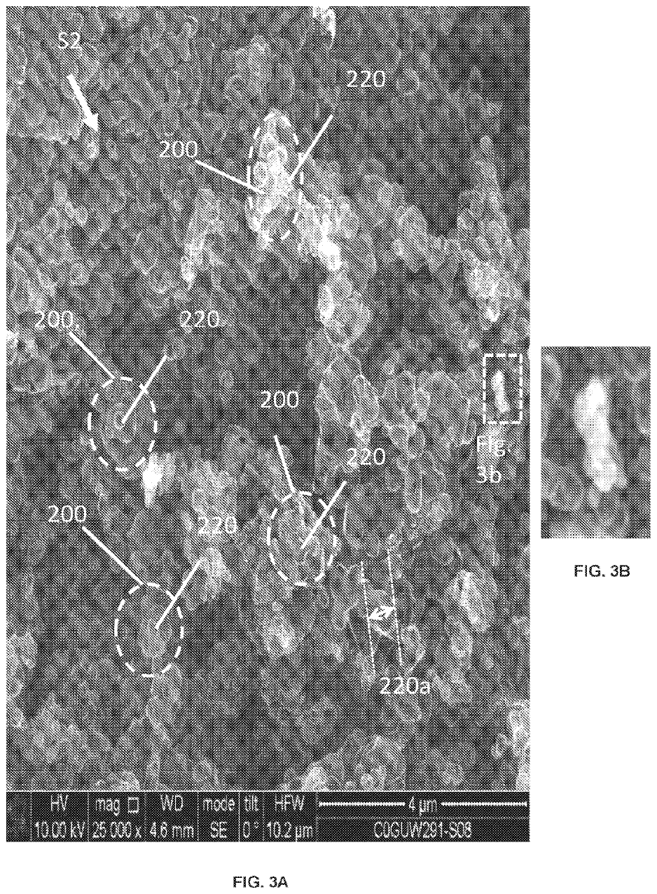

FIG. 3A shows particles 200 of a powder (S2) prepared according to the second embodiment. A comparison of FIG. 3A with FIG. 2A shows that the cells 220 of S2 are more discrete and less interconnected than the cells 120 of Si. FIG. 3A also shows that cells 220 in this powder are larger than 200 nm in diameter (see, e.g., 220a, the diameter of an exemplary cell which is approximately 400 nm).

FIG. 3B is a magnification of the indicated portion of FIG. 3A showing a minor phase of cellular carbon particles impregnated with residual MgO template material as a result of imperfect or incomplete acid extraction of the template. The impregnated cellular carbon particles appear opaque compared to the unimpregnated cells due to the presence of the template.

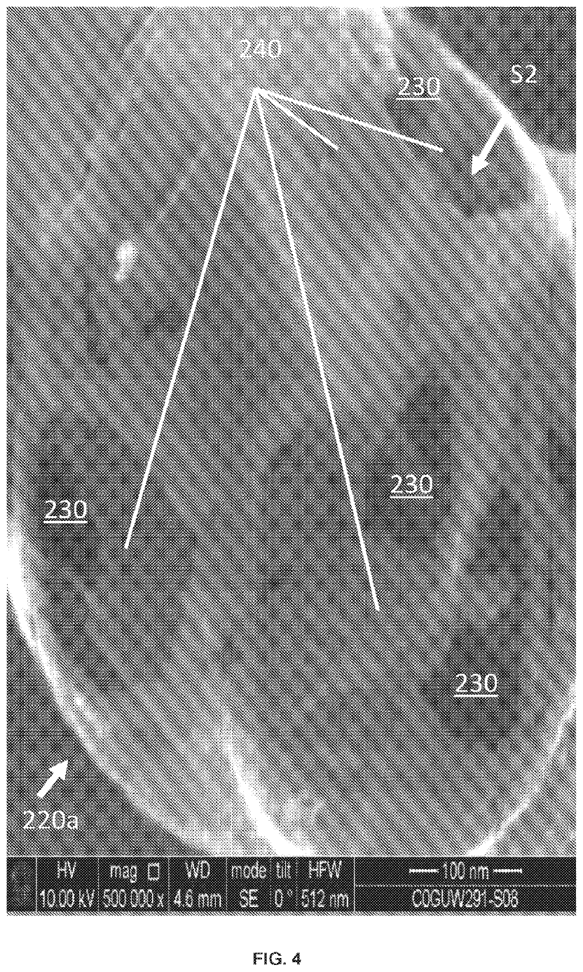

FIG. 4 shows an individual cell 220a of S2 powder in which transverse pores 230 through the cell walls have been covered by nearly-transparent carbon sheets 240. The carbon sheets 240 are grown during the secondary CVD process step described above. The sheets 240 form “patches” overlaying the transverse pores 230 that may reduce the permeability of the cells 220a when the cells 220a come into contact with liquid polymers or resin. In this way, the secondary CVD process has the potential to seal holes in the cell walls created by MgO (or other) template extraction.

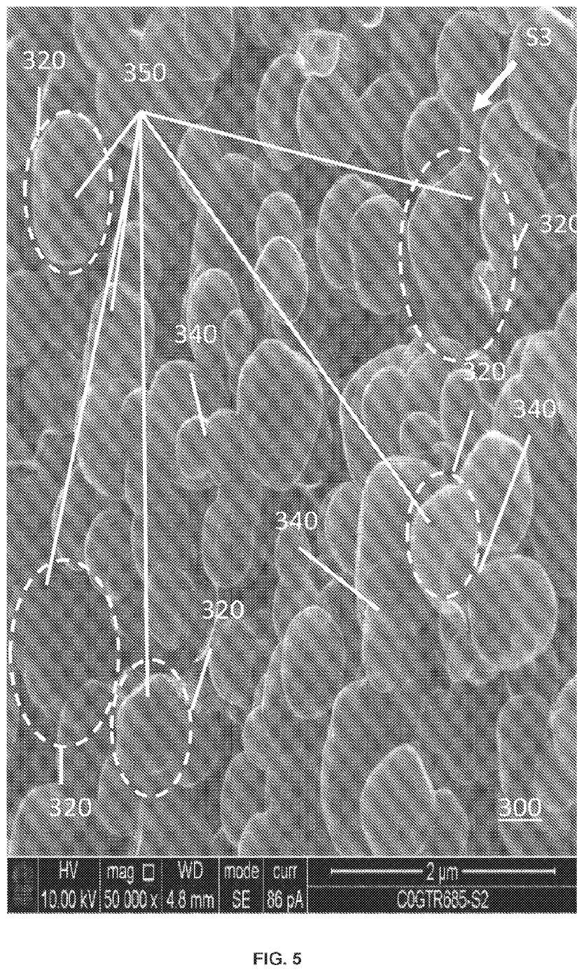

FIG. 5 shows a particle 300 of a powder (S3) prepared according to the third embodiment. Unlike particles prepared according to the first and second embodiments (S1 and S2, shown in FIGS. 2A and 3, respectively), the particles prepared according to the third embodiment (S3) axe generally spheroidal. This morphological difference is not due to the template feedstocks, since S2 and S3 were grown on EL170. Instead, the difference in morphology is due to the different temperatures of the pre-CVD heating treatment (1050 °C for S3 vs 750 °C for S2). Higher temperature, in the case of S3, results in more sintering, and smoother/larger particles. As shown in FIG. 5, most cells 320 in S3 are connected to one or more neighboring cells 320 via “bridges” 340, or connecting pieces of carbon. FIG. 5 also shows that the walls of cells 320 possess unpatched holes 350 (in contrast to the patched pores shown in FIG. 4), since no secondary CVD process was applied to patch the holes. However, it is understood that such a process could be applied to, among other things, seal the holes 350 in cells 320.

### Carbon/Polymer Composite Preparation

In a fourth embodiment, Carbon/polymer composites may be created by combining one or more of powders Si and S2 with an exemplary polymer “binder” Polyolefin 164-1 (100% solids) or “CPO.” Two composite powder samples C1 and C2 may be made from powders produced according to the first and second embodiments (e.g., Si and S2), respectively. It is to be understood that other powder combinations are within the scope of this disclosure.

As used herein, the term “binder” will generally refer to an additive used to create a composite material with the carbon powders (e.g., S1-53). A “binder” may chemically bind to the carbon powders. Alternatively, the “binder” may not bond chemically to the carbon. The binder may, for example, simply provide structural support to the resulting composite. Although CPO is provided as an exemplary binder, it is to be understood that any binder suitable for providing sought-after properties of the composite could be used. Other exemplary binders include other suitable polymeric materials. Binders may also include metallic materials, ceramics, or other carbon materials. Ceramic binders could be generated via functionalization of the carbon with metal oxides, followed by sintering, or via pyrolyzing an inorganic polymer precursor such as polysiloxane. Examples of other carbon materials that could be used as a binder include, but are not limited to, pyrolytic carbon materials generated via thermal decomposition of polymeric precursors. Still other binders may include thermoplastics, such as poly(methyl methacrylate), acrylonitrile butadiene styrene, polyamide, polylactic acid, polybenzimidazole, polycarbonate, polyether sulfone, polyoxymethylene, polyether ether ketone, polyetherimide, polyethylene, polyphenylene oxide, polphenylene sulfide, polypropylene, polystyrene, polyvinyl chloride, polytetrafluoroethylene, or copolymers thereof. Binders may also include thermosetting polymers, such as polyester, polyurethane, polyurea, phenol-formaldehyde, urea-formaldehyde, epoxy, benzoxazine, polyimide, bismaleimide, polycyanurate, polysiloxane, vinyl ester, or blends thereof.

The CPO binder may be obtained from Eastman Chemical Company and have a chlorine content between 17.5% and 23%. One control sample (CO) was made from the CPO binder alone without cellular carbons.

To make composite powders according to this embodiment (e.g., C1 and C2), two solutions of CPO in toluene may first be made. Each solution may be made by dissolving 2.4 grams of CPO powder into 40 grams of toluene. Each solution may be magnetically stirred for 30 minutes. Then 1.6 grams of carbon Si may be added to one of the solutions used to make C1, and 1.6 grams of carbon S2 may be added to the other solution used to make C2. Each solution may be magnetically stirred for 10 minutes in order to wet the carbon surfaces. Subsequently, each CPO/toluene solution may be subjected to 30 minutes of bath sonication using a Branson 8510DTH to disperse the carbon throughout.

Next, the CPO in each solution may be coated onto the surface of the dispersed carbon particles. To accomplish this, each solution may be subjected to a destabilization treatment to remove the CPO from the solution phase. This destabilization may be accomplished by adding 120 grams of isopropyl alcohol (IPA) in a dropwise fashion into each of the solutions. The IPA may be added at a rate of about 15 g/min, while stirring, to facilitate the complete removal of the CPO from solution. CPO-coated carbon particles may then be filtered from each solution and rinsed with IPA. Each of the resulting CPO-carbon retentates may be dried at −80 °C overnight, then ground with a mortar and pestle, resulting in two samples of fine composite powder, C1 and C2, corresponding to cellular carbons Si and S2, respectively.

The two exemplary composite powder samples, C1 and C2, according to this embodiment were produced in the above-described manner. A control powder sample CO of CPO binder alone was also produced.

Composites according to this embodiment may be mold compressed as follows. Samples may be loaded into a cylindrical compression mold designed to be compressible by tightening screws. Once loaded with powder, the mold may be placed into an oven preheated to 150 °C. The mold may then be kept in the oven for 20 minutes, allowing the CPO to soften. Subsequently, the mold may be removed from the oven and the sample may be compressed by tightening the screws on the mold with a torque wrench. The compressed mold may then be placed back in the oven at 150 °C for another 20 minutes, after which it may be removed once more and allowed to cool to room temperature. The sample specimens may then be ejected from the mold at room temperature, and the flat surfaces of the sample specimens may be polished in order to provide a uniform surface for compression testing.

Each sample CO, C1, and C2 was produced in the above-described manner and then tested for compressive strength and compressive modulus. The tests were performed according to the ISO 844 standard using cylindrical specimens. The crosshead speed of the tester was 1.0 mm per minute.

### Comparison of Compression-Molded Specimens

Sample specimen dimensions were assessed using a Mitutoyo digital caliper as follows. Four separate diameter measurements (D1-D4) and three separate height measurements (H1-H3) were obtained, along with specimen weights.

Table I compiles the results. As shown in Table 1, the diameters and heights of the specimens ranged from 12.0-13.0 mm and 14.0-18.0 mm, respectively.

TABLE 1

| | Mass | D1 | D2 | D3 | D4 | Hi | H2 | H3 |
|---|---|---|---|---|---|---|---|---|
| Sample | (g) | (mm) | (mm) | (mm) | (mm) | (mm) | (mm) | (mm) |
| CO | 1.584 | 12.96 | 12.73 | 12.86 | 12 ( )5 | 12.79 | 12.76 | 12.78 |
| Cl | 1.145 | 12.46 | 12.48 | 12.32 | 12.30 | 12.29 | 12.23 | 12.29 |
| C2 | 0.802 | 12.83 | 12.87 | 12.96 | 13.01 | 13.38 | 13.37 | 13.41 |

Specimen density was then determined by using the above-measured dimensions in conjunction with weight measurements. Table 2 reports the average dimensions, and the accompanying volume and density of the specimens.

TABLE 2

| | Avg | Avg height | Volume | Carbon | CPO | Density |
|---|---|---|---|---|---|---|
| Sample | diameter | (mm) | (cm³) | Percentage | Percentage | (g/cm³⁻ |
| CO | 12.88 | 12.78 | 1.663 | 0% | 100% | 0.952 |
| Cl | 12.39 | 12.27 | 1.479 | 40 ? 0 | 60°, 0 | 0.774 |
| C2 | 12.92 | 13.39 | 1.754 | 40% | 60% | 0.457 |

Table 2 shows that C1 and C2, the carbon-containing composites, were significantly less dense than CO, the polymer control. Solid carbon is denser than the CPO. Therefore, these results are likely explained by the high degree of porosity in the C1 and C2 samples. Note that C2 density was extremely low, less than 50% of the density of CO and only slightly more than 50% of the density of C I. This implies that the degree of porosity in C2 is relatively high.

The structure of the CI composite powder and C1 molded specimen was assessed using SEM in order to see the result of the CPO coating procedure on the carbon particles.

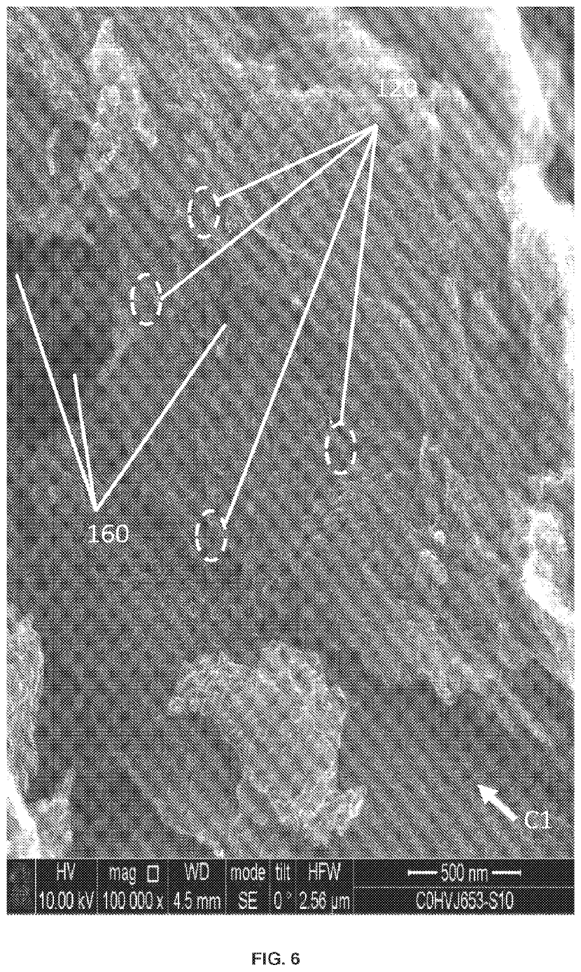

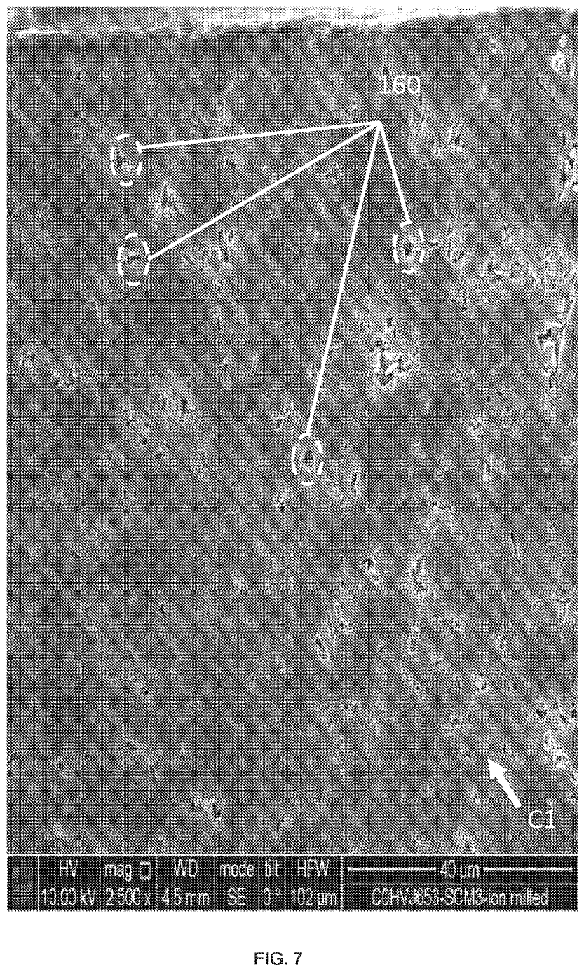

FIG. 6 is an SEM micrograph of the C1 composite powder prior to densification in the mold. Several features of Si powder are visible in FIG. 6, including cells 120 of Si, as well as intercellular pores 160. FIG. 6 shows that the CPO is virtually indistinguishable from the carbon (S1) in the SEM image. No obvious phases of CPO could be observed throughout the sample. This implies that the CPO polymer wetted the carbon evenly.

FIG. 7 is an SEM micrograph that shows the structure of C1 after densification in the compression mold and subsequent heating causes the CPO to fuse the carbon cells together into a cylindrical composite specimen. More specifically, FIG. 7 shows a cryo-ion milled cross-section of such a specimen.

As shown in FIG. 7, large, irregular intercellular micron-scale pores 160 shown in FIG. 6 remain distributed throughout the molded C1 composite specimen after densification, reflecting incomplete densification. Pores 160 have shapes that appear to be independent of the size and morphology of the carbon cells 120 in C1/S1. Rather, pores 160 appear large enough to be intercellular, although FIG. 7 does not clearly show individual cells 120. This intercellular porosity may result from a limited packing efficiency of the carbon nanostructure represented by C1, insufficient densification due to insufficient compression, lack of sufficient amounts of free-flowing CPO to fill these spaces, and/or potentially cavitation at the CPO/S1 (carbon) interface resulting from the removal of the cooled C1 composite specimens from the mold.

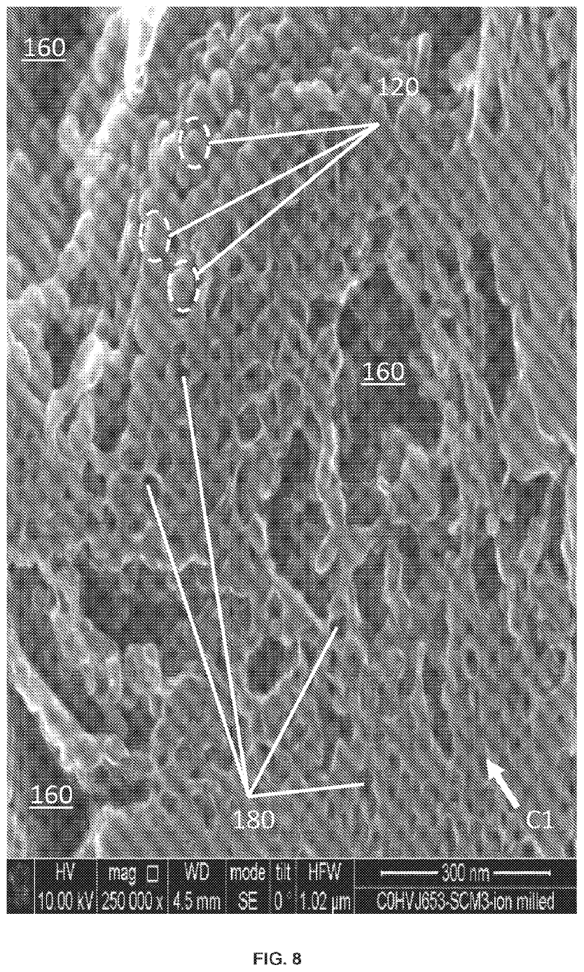

FIG. 8 is a higher magnification SEM micrograph of the cryo-ion milled cross-section of the C1 pellet in FIG. 7. At the level of magnification shown in FIG. 8, a second mode of pores 180 of intracellular or endohedral porosity can be observed in addition to the intercellular pores 160 shown in FIG. 7. The second mode of pores 180, which have diameters of 50 nm or smaller, are found throughout the cross-section. Close examination of FIG. 8 reveals that the second mode of pores 180 appear to correspond to the cavities of cells in the S1 structure (see, e.g., cells 120 in FIGS. 2C and 8).

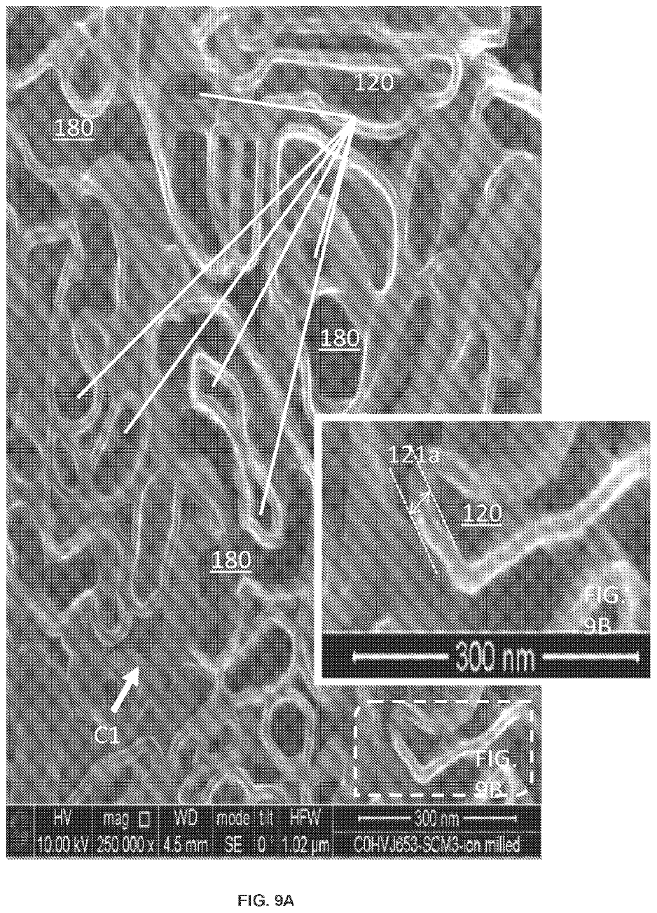

FIG. 9A is another cross-sectional SEM image of C1. FIG. 9A shows a cluster of cells 120. In the cluster, what appear to be gas-filled carbon cells (otherwise referred to herein as “endohedral voids”) 120 and intercellular voids 180 are both present. Both modes of porosity lower the density of the composite, explaining the result that the density of C1 samples is lower than CO (Table 2).

FIG. 9B is an inset, magnified portion of FIG. 9A showing an individual cell 120. As shown in FIG. 9B, the cell wall and adsorbed layer of CPO 121a appears approximately 30 nm thick, which is far thicker than the cell wall 121 alone. The average thickness of the cell walls 121 in a nanostructured carbon may vary from a few nm up to 100 nm.

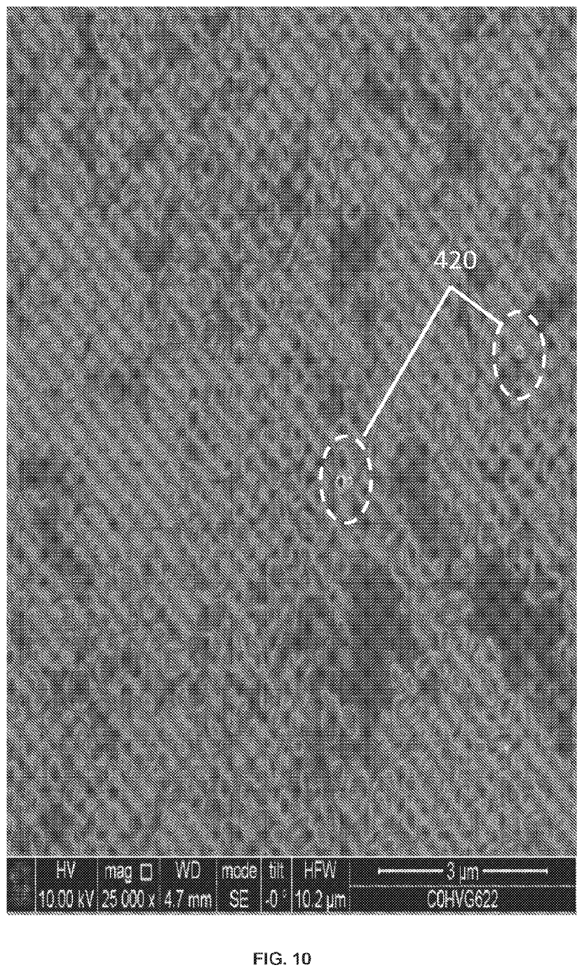

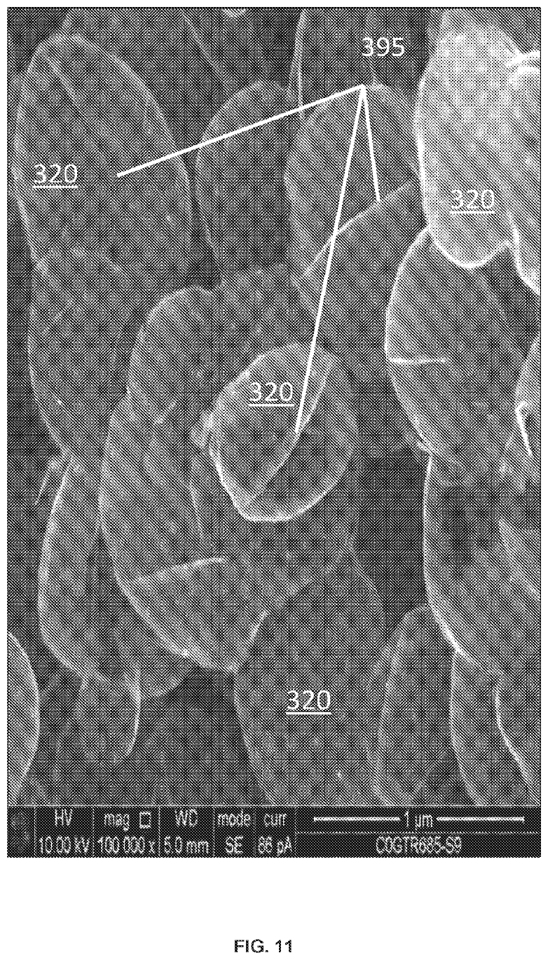

For the sake of comparison, FIG. 10 is an SEM image of a cryo-ion milled cross-section of a compression-molded composite with a higher CPO content than either C1 or C2 composites. The composite shown in FIG. 10 is 90% CPO, by weight, and 10% cellular carbon. The compressive force during molding, combined with the porous cell walls and the higher CPO content of the composite in FIG. 10, facilitates the polymer's impregnation of the cells and intercellular spaces. In fact, only a few unimpregnated cells 420 are visible in the image. Like the unimpregnated cells 120 in FIGS. 8-9, the unimpregnated cells 420 in FIG. 10 can be identified by the relative darkness of the unimpregnated cell cavities as well as a lighter, charging effect of the cell walls surrounding the cavities. The unimpregnated cells 420 appear in stark visual contrast to the surrounding impregnated cells.

### Conductivity Testing

The electrical sheet resistance of CO, C1, and C2 was measured with a Keithly 2400 SourceMeter 4 point probe. The measurement confirmed CO as an insulator (no reading). Cl had an average sheet resistance of 1.58 Cl/sq and a minimum sheet resistance of 1.46 S2/sq. C2 had an average sheet resistance of 2.51 fl/sq and a minimum sheet resistance of 2.46 fl/sq. Each reported sheet resistance is the average of three separate measurements.

These results show that the sheet resistance of each of the samples is relatively low when compared to typical insulative polymeric materials, such as CO. This implies that the carbon forms a conductive network throughout the composite, despite being coated by polymer. This suggests that composite materials reinforced with cellular carbons, such as S1-S3, may be desirable for applications requiring light-weight, conductive materials. Such applications may include “smart” composite materials including the capability of piezoresistive sensing.

### Mechanical Testing

The mechanical properties of C1 and C2 specimens were tested on a hydraulic universal testing system with a compression subpress fixture supplied by Wyoming Test Fixtures and a 3000 lb (13345N) load cell. The testing system was operated at a constant crosshead speed of 1 mm per minute. Data was recorded in real time using a National Instruments USB-6341 data acquisition system connected to a Windows PC. Strain data was measured using a deflectometer (Model 3540) supplied by Epsilon Technology Corporation.

Table 3 shows measured compressive strength for CO, C1, and C2. Compressive strength was measured at 10% strain for samples that did not reach their ultimate compressive strength during the measurement. Otherwise, the compressive strength given in Table 3 is the ultimate compressive strength. Table 3 also shows the compressive modulus for samples CO through C2.

TABLE 3

| | Compressive Strength at 10 c,′^{,} i) strain or | | | | |
|---|---|---|---|---|---|
| | Ultimate Compressive Strength | | | Compressive Modulus | |
| Sam- | Stress | Strain | Improve- | Modulus | improve- |
| ple | (MPa) | (%) | ment | (MPa) | ment |
| (.′(.) | [symbol] | 10.0 | [symbol] | 107.9 | 0% |
| \grave{ }, 1 | 50.42 | 8.47 | 627% | 800.1 | 642% |
| C″) | 16.87 | 10.0 | 143% | 299.4 | 177% |

[symbol]

indicates data missing or illegible when filed

Both the compressive strength and modulus of the porous composite materials, C1 and C2, are much higher than the CO sample, which is CPO polymer without any carbon added. This result shows that adding carbon materials to CPO strengthens and stiffens the composite.

TABLE 4

| | Specific Compressive Strength | | | |
|---|---|---|---|---|
| | at 10% strain or Specific | | | |
| | Ultimate Compressive Strength | | Specific Compressive Modulus | |
| Sam- | Specific Strength | Improve- | Specific | Improve- |
| ple | (MPa/g/cm³) | ment | Modulus | ment |
| CO | 7.29 | 0% | 113.3 | 0% |
| C1 | 65.14 | 794% | 1034 | 812% |
| C2 | 36.91 | 406% | 655.1 | 478% |

As shown in Table 4, which gives the specific strength and modulus of CO, C1, and C2, the effect of adding carbon on the composite's mechanical properties are even more dramatic. The table shows that adding S1 to CPO in composite C1 improves specific strength and specific modulus by around 800%.

The improvements in mechanical properties are likely due to the distribution of load in the composite. For example, the strength improvements may result from improving stress transfer from the polymer to the cellular carbon reinforcing phase. The modulus improvements suggest that the C1 composite effectively distributes the compressive load around both the endohedral and intercellular voids. Voids in non-rigid polymers like CPO tend to yield before the matrix, resulting in significant compaction (e.g., increasing the compressive strain without significantly increasing stress) and a correspondingly low compressive modulus.

C1 and C2 composite specimens also exhibited improved shape retention upon compression testing when compared to comparable composite materials. Specifically, when the compressive force applied by the test frame was released, the C1 and C2 specimens relaxed back to dimensions within a few percent of their pre-testing dimensions shown in Table 1. Strain tests also revealed similar results. In the strain tests, a C1 sample was compressed multiple times at increasing amounts of stress and strain. Sample dimensions were measured after each individual compression test. The measured dimensions were then used to calculate stress and strain in the next iteration.

The results, reported in Table 5, were as follows. The average of four diameter and height measurements made via calipers was determined prior to each test. Based on the average diameter and height, and based on a specimen mass of 0.687 grams (unchanged throughout all 7 tests), the densification of the specimen was tracked along with the force applied, strain obtained, and compressive stress.

TABLE 5

| Test | Average | Average | Density | Force | Strain | Stress |
|---|---|---|---|---|---|---|
| # | diameter | height (mm) | (g/cm⁻)³ | Applied (N) | (%) | (MPa) |
| 1 | 13.09 | 14.89 | 0.343 | 1103 | 3.84% | 8.19 |
| 2 | 13.03 | 14.86 | 0.347 | 1188 | 4.37% | 8.92 |
| 3 | 13.05 | 14.79 | 0.348 | 1549 | 9.27% | 11.59 |
| 4 | 13.02 | 14.71 | 0.3.51 | 1572 | 9.56% | 11.81 |
| | 13 00 | 14.66 | 0.349 | 2115 | 20.32% | 15.72 |
| [symbol] | 1_;.09 | 1- .50 | 0.352 | 2132 | 20.64° 0 | 15.84 |
| — | [symbol] | [symbol] | 0.349 | :1481 | 39.39% | 24.46 |
| | 13.32 | 14.16 | 0.348 | — | — | — |

[symbol]

indicates data missing or illegible when filed

The relatively low values of strain shown in Table 5 suggest that the composite materials have a certain amount of “shape memory,” particularly when the applied force is relatively low (i.e., when the applied force is below 1600 N, the shape is retained to within 10%). This sets composite C1 apart from typical rigid foams, such as syntactic foams or CPO by itself, which normally exhibit very little elasticity.

Table 6 shows how the composite CI retains this “shape memory” even at relatively high strains.

TABLE 6

| | | | | Permanent | Permanent |
|---|---|---|---|---|---|
| | | | | Height | Height |
| Test | | Sample | Rebound | Deformation | Deformation |
| # | Strain (%) | Deflection | (mm) | (mm) | (%) |
| 1 | 3.84°, 0 | 0.57 | 0.54 | 0.03 | 0.18% |
| 2 | 4.37% | 0.65 | 0.55 | 0.10 | 0.67% |
| 3 | 9.27% | i S7 | 1.20 | 0.17 | 1.17% |
| 4 | 9.56% | 1.41 | 1.18 | 0.23 | 1.54% |
| 5 | 20.32% | 2.98 | 2.60 | 0.37 | 2.58% |
| 6 | 20.64% | 2.99 | 2.54 | 0.45 | 3.15% |
| 7 | 39.39% | 5.68 | 4.99 | 0.69 | 4.90% |

In particular, Table 6 shows that the specimen recovered up to slightly more than 95% of its original height (height deformation of less than 5%) even when subjected to a strain of nearly 40%. This extraordinary shape retention is likely attributable to the ability of the carbon cells to deform under high stress, then return to their original dimensions.

The cellular carbons described herein may be particularly effective at recovering their shape after deformation due to their defect-engineered carbon lattice structures. As described in PCT/US17/17537 such as those used in the present disclosure may cause the formation of lattice defects throughout the cell walls. Theoretical models have predicted that topologically defective lattices would be more ductile than crystalline graphene. Another possibility is that sp^{a}-hybridized bonds may have been formed between the lattices comprising the cell walls, preventing the lattices from shearing over one another. Interlayer shear is a likely mechanism for the wall to stress-relax during compression.

FIG. 11 shows the results of uniaxial compression testing on cellular carbon sample S3 at a pressure of approximately 250,000 psi. The effects of compressing the cells 320 can be seen in the linear buckling 395. The linear buckles 395 reflect yielding due to stress concentration during compressive deformation of the cells 320. Despite the cell wall buckling, the cells 320 have apparently recovered their generally spherical shape after being flattened. This indicates their ability to store and release elastic potential energy, which again suggests that the cell walls are prevented from stress-relaxing via interlayer shear.

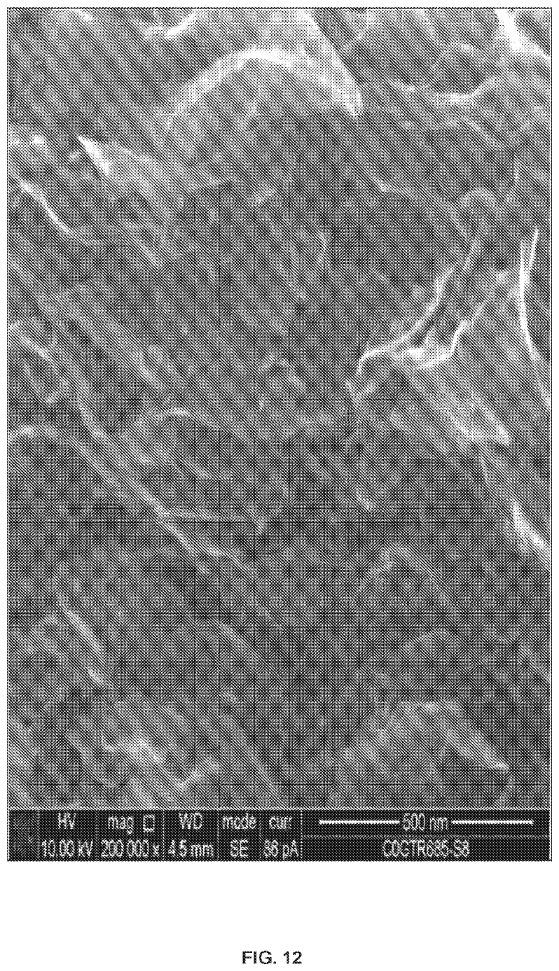

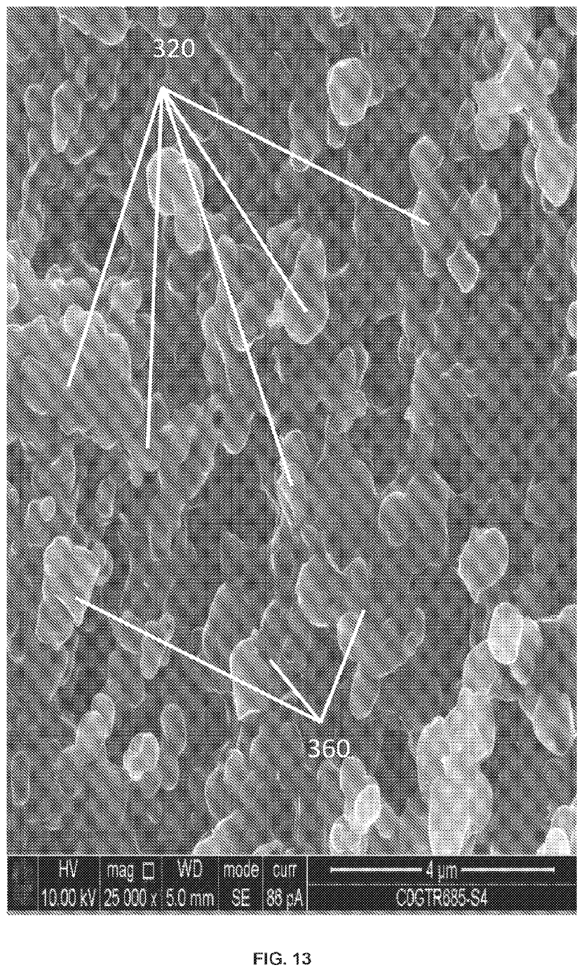

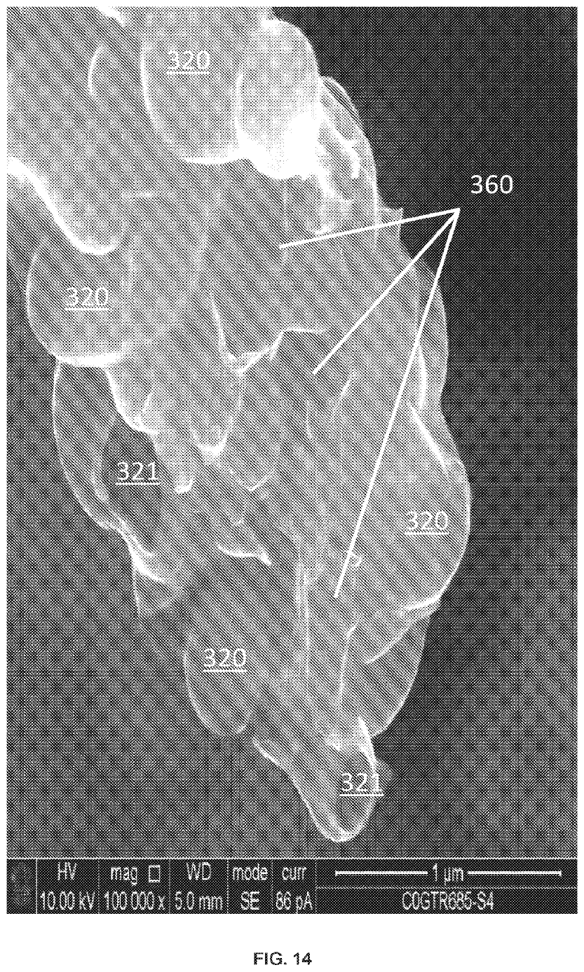

Crystalline cellular carbons, by contrast, exhibit irreversible crushing after 250,000 psi compression. Unlike defect-engineered cellular carbon powders such as S1-S3, which were not pelletized by compression of the powder up to 250,000 psi, crystalline cellular carbon powders were readily pelletized by compression of the powder and formed a dense pellet. FIG. 12 is an SEMI micrograph of a sp²-hybridized crystalline cellular carbon after being subjected to 250,000 psi of uniaxial compression. Specifically, the image shows collapsed spheroidal cellular carbons, that were subjected to the same compression process as the cellular carbons shown in FIG. 11. The carbons in FIG. 12 were grown by a higher temperature CVD growth process (1050 °C), whereas the cells 320 shown in FIG. 11 were grown by a lower temperature CVD growth process (750 °C). The carbons in FIG. 12 were crushed irreversibly, likely flattening as the lattices comprising the cell walls sheared over one another. As a result, the cells did not regain their shape or porosity after the compressive force was removed. The cells also exhibit more wrinkles and folds than the cells 320 in FIG. 12 that were subjected to the same uniaxial compression. The wrinkles may result from the topological mismatch between the planar graphitic cell walls and the curved template surfaces.

### Composite Materials as Coating

In still other embodiments, the composites of the above embodiments may be used as coatings. To create a composite coating of this embodiment, carbon powder may be slurried and dispersed in a solution of CPO and toluene (10:1 toluene by weight). The S3 powder may be 10% of the solids content of the composite materials. The liquid composite may then be applied as a thin coating over a metal substrate and allowed to dry at room temperature. FIGS. 13 and 14 show the results of an experiment to demonstrate the suitability of unimpregnated cellular carbon composites for coating applications. The powder used in this experiment was S3 and the coating created by it will be referred to as “C3.”

FIG. 13 shows an SEM micrograph of the composite coating C3. As shown in FIG. 13, the coating C3 includes regular spheroidal cells 320 packed together in a syntactic architecture and blanketed with CPO binder 360, mainly visible as a connective layer between neighboring cells 320 in a cluster. If the CPO binder 360 were not present, each cell 320 would be more distinct and separate, as, for example, the cells 320 shown in FIG. 5.

FIG. 14 shows a high-magnification micrograph of a composite particle scraped from the dried C3 coating shown in FIG. 13. The unimpregnated cavity structure of the cells 320 can be observed in ruptured cells 321. Other unimpregnated cavity structures embedded just below the surface of the CPO binder 360 can be discerned. It is likely that CPO is deposited both on the exohedral and endohedral cell surfaces, given the transverse pores present in the S3 cell walls. Nevertheless, volumetrically the cells are substantially unimpregnated. FIG. 14 also clearly shows the size scale of cells 320 are fractions of a micron in diameter. This cavity size scale is many times smaller than pores created by tradition material “foaming” methods, e.g., by creating foams by blowing bubbles in molten material. For example, a 100 nm diameter cellular carbon sphere has a volume that is one million times smaller than a 10 ttm diameter gas bubble. A coating that is 1 mil in thickness may therefore hold numerous cellular carbon spheres instead of a just a few. Therefore, thin coatings of cellular carbon composites, especially those with syntactic architectures, may be advantageous.

### APPLICABILITY

It is to be understood that the above-described cellular carbon composite material may have a number of applications beyond those explicitly described herein. Some additional exemplary applications include lightweight coatings that provide pressure-variable electrical or thermal conductivity properties. These applications may include damage or fatigue sensors and/or damage or fatigue sensing components on vehicles, such as aircraft or automobiles. Other applications may include ballistic sensing where, for example, the composites are incorporated into armor, military hardware, or other objects potentially exposed to ballistic impact. They may also include molded and/or coating composite applications in actuators or accelerometers for measuring, for example, motion or trajectory.

Control over the cell morphology in unimpregnated cellular carbons allows for more versatility in composite property engineering and application than typical means of foam formation (e.g., using glass bead templates). For example, unimpregnated cells packed together with sufficient density may form a syntactic architecture—e.g., an arrangement of hollow, cellular particles packed densely enough to contact each other. Potential sizes and geometries of unimpregnated cellular carbons are numerous and varied. They range from spheroids to complex multicellular sheets and fibers. Smaller-diameter particles with nanostructured carbon walls may offer lower density and superior mechanical properties as compared to hollow glass. Unimpregnated cellular carbons may also be used to create highly electrically conductive syntactic architectures for applications benefiting from multi-functionality. Such composites may be useful for electromagnetic shielding, resistive heating, and piezoresistive sensing. Unimpregnated cellular carbon nanostructures may also be internally pressurized in order to improve their resistance to compression.

The preceding description of the disclosed examples is provided to enable any person skilled in the art to make or use the present examples. Various modifications to these examples will be readily apparent to those skilled in the art, and the generic principles defined herein may be applied to some examples without departing from the spirit or scope of the written description. Thus, the present disclosure is not intended to be limited to the examples shown herein but is to be accorded the widest scope consistent with the following claims and the principles and novel features disclosed herein.

1. A method of making a porous composite, comprising:
calcining template precursor particles to obtain a powder of template particles, each particle comprising interconnected metal oxide structures; and
growing a nanostructured carbon shell around each template particle, the carbon shell comprising one or more graphene layers encapsulating the interconnected metal oxide structures, the growing comprising a template-directed chemical vapor deposition; and
extracting the template particles from the nanostructured carbon shells to form templated carbon particles containing endohedral pores, where each templated carbon particle's endohedral pores are encapsulated by its nanostructured carbon shell, the shell comprising endohedral and exohedral surfaces; and
dispersing the templated carbon particles in a liquid containing a dissolved or dispersed polymeric binder; and
adsorbing the polymeric binder to the exohedral surfaces of the templated carbon particles and drying the liquid to form a polymer coating around the templated carbon particles, such that the polymer-coated templated carbon particles retain endohedral pores; and
forming a porous composite network by coalescing the binder coatings around the templated carbon particles, the porous composite network retaining the endohedral pores.

2. The method of claim 1, wherein calcining the template precursor particles comprises decomposing them to form porous magnesium oxide template particles.

3. The method of claim 1, wherein the interconnected metal oxide structures comprise a fine structure of discretized features within a metal oxide microstructure.

4. The method of claim 1, wherein the template-directed chemical vapor deposition comprises an autocatalyzed carbon growth.

5. The method of claim 1, wherein the template-directed chemical vapor deposition comprises a temperature of at most 800 °C.

6. The method of claim 1, wherein the template-directed chemical vapor deposition comprises forming sp³-hybridized bonds between the one or more graphene layers.

7. The method of claim 1, wherein the template-directed chemical vapor deposition comprises growing a disordered carbon characterized by a 532-nm Raman spectrum having an I_{2D}/I_{G} peak of at most 0.20.

8. The method of claim 1, wherein the polymeric binder comprises a thermoplastic.

9. The method of claim 1, wherein:
the liquid comprises a thermoplastic dissolved in an organic solvent; and
the adsorbing comprises precipitating the thermoplastic from the organic solvent.

10. The method of claim 1, wherein forming the porous composite network comprises molding the polymer-coated templated carbon particles.

11. The method of claim 1, wherein forming the porous composite network comprises applying the polymer-coated templated carbon particles to a substrate and then drying the liquid to form a composite coating.

12. The method of claim 1, wherein forming the porous composite network comprises packing the polymer-coated templated carbon particles into a syntactic arrangement.

13. The method of claim 1, further comprising:
after extracting the template particles and before dispersing the templated carbon particles in the liquid, sealing the nanostructured carbon shell to enclose the endohedral pores.

14. The method of claim 1, wherein the polymeric binder comprises a thermosetting polymer.

15. The method of claim 1, wherein the polymeric binder comprises a further comprising:
after forming the porous composite network, heating the porous composite network to transform the polymeric binder to a ceramic binder.
